(19) United States
(12) Patent Application Publication
(10) Pub. No.: US 2009/0267741 A1
(43) Pub. Date: Oct. 29, 2009

(54) RFID Floor Tags for Machine Localization and Delivery of Visual Information

(76) Inventors: Eric Chun-Yip Li, Minnetonka, MN (US); Peter A. Swenson, Minneapolis, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 12/430,752

(22) Filed: Apr. 27, 2009

Related U.S. Application Data
(60) Provisional application No. 61/048,070, filed on Apr. 25, 2008.

(51) Int. Cl. H04Q 5/22

(52) U.S. Cl. 340/10.1

(57) ABSTRACT

An RFID system for a portable cleaning machine having RFID reader. Location of the machine within a floor field is achieved by detecting one or more of a plurality of floor-applied RFID tags as the cleaning machine traverses the floor field. Each RFID tag includes a tag carrier including visual indicia providing personnel with instructions or warnings or directions. An operator of the machine may reference the visual indicia of the RFID tag carriers as the machine traverses the floor field.

### RELATED APPLICATIONS

This application claims the benefit of priority of U.S. Ser. No. 61/048,070, filed Apr. 25, 2008, and which is hereby incorporated by reference in its entirety.

### TECHNICAL FIELD

The present invention relates generally to machine localization using RFID technology. More particularly, the invention relates to techniques and devices for portable machine localization based on signals received from one or more radio frequency tags dispersed throughout a field within which the location of the portable machine is to be determined. Yet more particularly, the invention relates to an RFID tag carrier providing visual informative content to personnel within the vicinity of the tag carrier.

### BACKGROUND OF THE INVENTION

In recent years, radio frequency identification (RFID) systems have been employed in an ever increasing range of applications. For example, RFID systems have been used in supply chain management applications to identify and track merchandise throughout manufacture, warehouse storage, transportation, distribution, and retail sale. RFID systems have also been used in security applications to identify and track personnel for controlling access to restricted areas of buildings and plant facilities, thereby prohibiting access to such areas by individuals without the required authorization. Accordingly, RFID systems have been increasingly employed in diverse applications to facilitate the identification and tracking of merchandise, personnel, and other items and/or individuals that need to be reliably monitored and/or controlled within a particular environment.

A conventional RFID system typically includes at least one RFID transponder or tag, at least one RFID reader, and at least one controller or host computer. For example, in a manufacturing environment, RFID tags can be attached to selected items of manufacture or equipment, and at least one RFID reader can be deployed in the environment to interrogate the tags as the tagged items pass predefined points on the manufacturing floor. In a typical mode of operation, the reader transmits a radio frequency (RF) signal in the direction of a tag, which responds to the transmitted RF signal with another RF signal containing information identifying the item to which the tag is attached, and possibly other data acquired during the manufacture of the item.

Whether implemented as computer peripherals or networked devices, conventional RFID readers generally collect data from RFID tags much like optical barcode readers collect data from barcode labels. However, whereas an optical barcode reader typically requires a direct line of sight to a barcode label to read the data imprinted on the label, the RF signals employed by the typical RFID reader can penetrate through objects obstructing an RFID tag from the RF field of view of the reader, thereby allowing the reader to access data from a tag that, for example, might be covered. In addition, unlike the optical barcode reader, the conventional REID reader can operate on and distinguish between multiple RFID tags within the field of the reader.

### BRIEF SUMMARY OF THE INVENTION

A system of object localization according to an aspect of the present invention employs a set of radio frequency identification tags (RFID) dispersed throughout a field. In one example, location of a portable machine within a field of RFID tags is determined by receiving and processing signals received from RFID tags in the vicinity of the machine. Each RFID tag also provides visual information to personnel local to the RFID tag. Signals from multiple tags can be employed in determining the location. Depending on the particular tags employed, the machine localization may be accomplished by associating locations with specific codes or by associating locations with possible paths that may be used to reach the locations.

An embodiment of the present invention includes a plurality of RFID tags, with each tag including a microchip, an antenna and a tag carrier that holds the microchip and the antenna in place. The tag carrier may be paper or plastic, with or without adhesive layer. When affixing the RFID tags on a concrete floor, a layer of adhesive can be applied to one side of the carrier. A tag dispensing machine can be developed for consistent placement of the tag carriers. Coatings can be applied after the RFID tag carriers are placed on the concrete floor. Conventional coating methods can be utilized. However, the layers of coating may need to be thicker than the RFID tags and carriers.

Tag size presents another limitation as it is desirable to put tags on concrete and cover them with a layer of coating for protection. RFID tags may still visible if the coating is transparent. If the layer of coating is pigmented, it may need to be thicker then the RFID tags in order to provide a smooth surface. An uneven coating surface can cause uneven wearing and build up of dirt, which can cause the RFID tags to be visible and/or subject to increased wear or damage.

The RFID tags can be concealed within an informative tag carrier under a floor coating. The REID tag carrier can be printed upon, sized or cut into informative shapes. Words, colors and/or symbols can be added to the RFID tag carrier. The REID carriers can be placed on the floor at specified locations and at predetermined orientations to form informative patterns on the concrete floor.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a perspective view a floor cleaning machine traversing a floor field having a plurality of RFID tags incorporated within a plurality of floor tiles in accordance to the present invention.

FIGS. 2 and 3 illustrate an embodiment of a tag carrier and RFID tags.

FIGS. 4 and 5 illustrate an embodiment of a tag carrier and RFID tags with visible indicia.

FIGS. 6-10 illustrate different applications of the tag carrier and RFID tag upon a floor surface.

FIGS. 11 and 12 illustrate different shapes and/or indicia of tag carriers 14 as depicted on a floor surface.

FIG. 13 illustrates aspects of another embodiment of a localization procedure in accordance with an embodiment of the present invention.

FIG. 14 illustrates aspects of another embodiment of a localization procedure in accordance with an embodiment of the present invention.

FIG. 15 illustrates aspects of another embodiment of a localization procedure in accordance with an embodiment of the present invention.

### DETAILED DESCRIPTION OF THE INVENTION

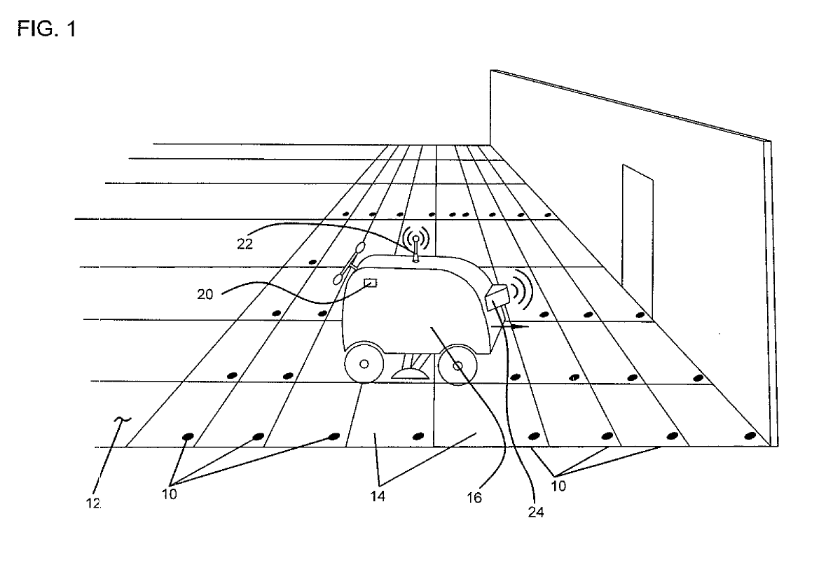

Referring to FIG. 1, REID tags 10 can be dispersed within a floor field 12. In this example, tags 10 are secured to the floor field via tag carriers 14. In one embodiment, the tags 10 are placed in a regular pattern upon the floor field 12. During operation of machine 16, tag information can be determined via tag reader (tag detector, tag interrogator) 24 and control system 20 carried on machine 16. Control system 20 may communicate via antenna 22 to a remote system for remote generation or reception of a facility map. The information can be transferred using a data cell phone connection to a file site on the Internet. RFID tags 10 can be placed in many different ways. For example, RFID tags 10 can be integrated in labels or stickers. The REID tags can be adhered to the floor surface with reference to visual indicia provide upon the tag carriers 14.

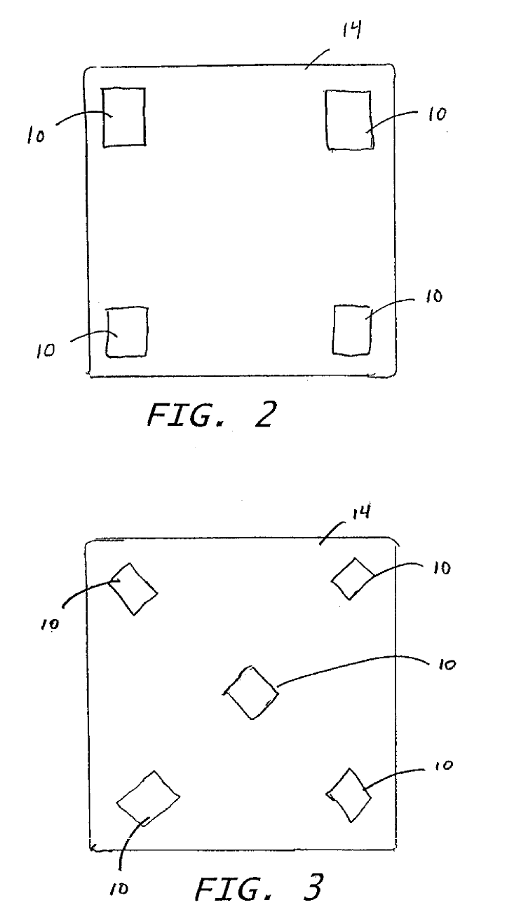

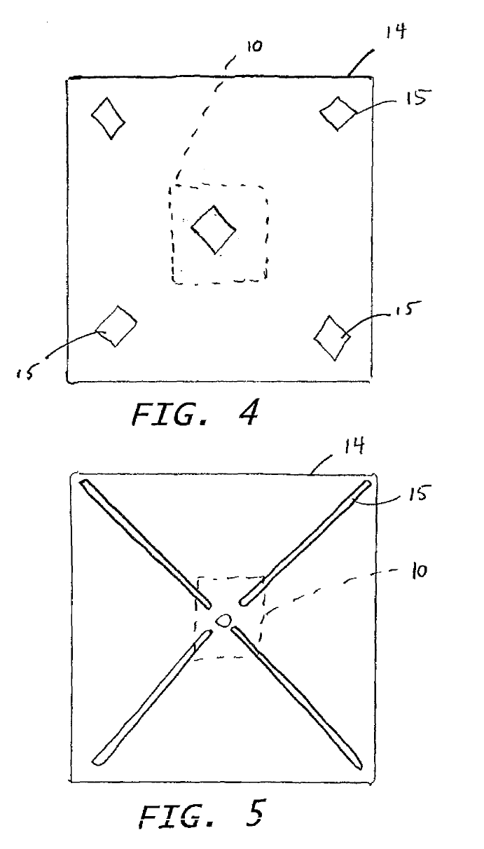

Referring to FIGS. 2-5, the RFID tags 10 can be secured to a flexible carrier 14, such as a paper or other polymer film which is secured to the floor field 12 via adhesives and/or coatings. FIGS. 2 and 3 illustrate a carrier 14 having a plurality of RFID tags 10. FIGS. 4 and 5 illustrate carriers 14 having a single RFID tag 10 and also having visible indicia 15 which facilitates accurate alignment and positioning of the carrier 14 upon the floor field. As shown, indicia 15 can assume a variety of different designs.

While carrier 14 is illustrated in square-form, other embodiments of carrier 14 may assume different geometric configurations, including but not limited to circular, oval, triangular, or may assume decorative configurations, including but not limited to stars, crosses, logos, names, directional arrows, etc.

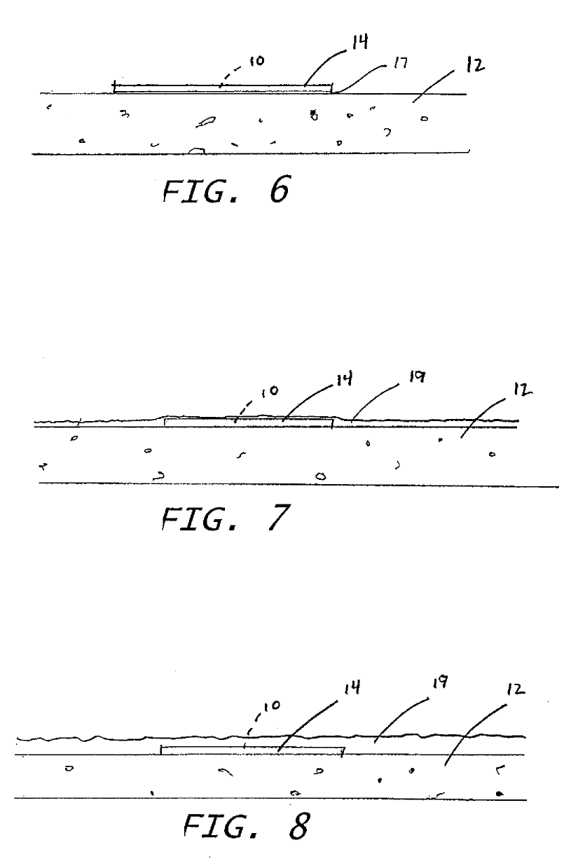

FIGS. 6-10 illustrate a few possible applications of RFID tag carriers 14 upon floor field 12. In FIG. 6, the tag carrier is adhered to floor field 12 via an adhesive 17, such as peel-and-stick adhesive layer. The adhesive 17 may be secured to the tag carrier 14 during manufacturing or combined with the carrier 14 during a site application.

In FIG. 7, the tag carrier 14 is secured to the floor field 12 via a floor coating 19, such as a floor epoxy, polyurethane, or other floor coatings. The floor coating 19 is placed over the tag carrier 14. In FIG. 8, a thicker floor coating 19 is applied to further protect the RFID tags 10 from damage.

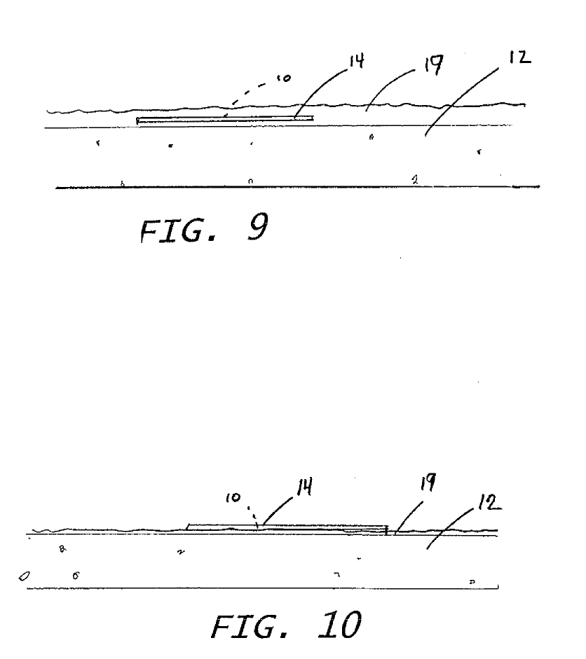

FIG. 9 depicts another application wherein the tag carrier 14 has been applied after a portion of the floor coating 19 has been applied. FIGS. 8 and 9 illustrate tag carrier 14 beneath the top surface of the floor coating 19. In this manner, floor surface coating 19 offers protection against damage to the REID tags 10. Floor coating 19 thus provides protection against damage for floor surface 12 and RFID tags 12. A variety of different liquid floor coating materials could be utilized for coating 19. For example, an epoxy or polyurethane compound could be used as coating 19.

FIG. 10 depicts yet another application wherein the tag carrier 14 is applied on top of the floor coating. In such an embodiment, the tag carrier 14 itself may provide any needed protection for the RFID tags 10.

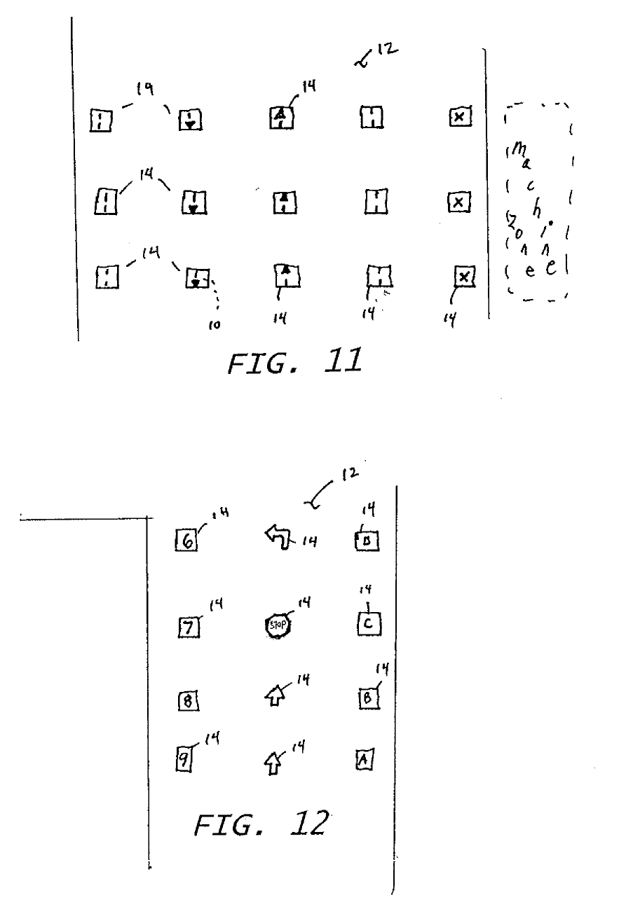

FIG. 11 illustrates a top view of an application of tag carriers 14 as applied upon a floor surface. Tag carriers 14 may include informative indicia 15 to provide information to local personnel. In the illustrated embodiment, the tag carriers 14 include directional and warning indicia. Tag carriers 14 and/or indicia 15 may be color-coded to suit a particular application or need. As described above, tag carriers 14 may be adhered to a floor surface or may be secured to the floor under a floor coating.

FIG. 12 illustrates a top view of another application of tag carriers 14. In this embodiment some of the tag carriers include warning or directional indicia, while others include numerical or alphabetical indicia. Informative tag carriers may be particularly useful in commercial and industrial applications to direct, warn, or otherwise inform personnel in the vicinity of the tag carriers.

It is intended that a wide variety of shapes, colors and sizes of tag carriers 14 and/or indicia 15 may be utilized in applications of the present invention. The examples shown in FIGS. 2-12 are not intended to be limiting in any manner.

Once the RFID carriers 14 and tags 10 are placed and a map has been created, the location of the machine can be determined during machine operation. This can be done by using a localization system along with a tag reader on the cleaning machine. Given the known placement of the RFID tags in an environment, and the shape of the scan volume of the tag reader, certain information about the location of the tag reader in the environment can be determined. This determination may be geometrical and can be extended with time information. Additional aspects of machine localization using floor-applied RFID tags are disclosed in applicant's U.S. application Ser. No. 12/264,345, entitled “Machine Localization Within a Field of RFID Tags”, the entire disclosure of which being incorporated by reference herein.

Significant customer value can be derived if a portable machine's location can be accurately determined within a building or other site. An embodiment of the present invention provides a system for locating a portable machine within a field of RFID tags. In one embodiment, the portable machine performs a cleaning function.

In an RFID system, each RFID tag typically includes a small antenna operatively connected to a microchip. For example, in the UHF band, the tag antenna can be just several inches long and can be implemented with conductive ink or etched in thin metal foil on a substrate of the microchip. Further, each tag can be an active tag powered by a durable power source such as an internal battery, or a passive tag powered by inductive coupling, receiving induced power from RF signals transmitted by an RFID reader. For example, an RFID reader may transmit a continuous unmodulated RF signal (i.e., a continuous wave, CW) or carrier signal for a predetermined minimum period of time to power a passive tag. The volume of space within which a reader can deliver adequate power to a passive tag is known as the power coupling zone of the reader. The internal battery of active tags may be employed to power integrated environmental sensors, and to maintain data and state information dynamically in an embedded memory of the tag. Because passive tags do not have a durable power source, they do not include active semiconductor circuitry and must therefore maintain data and state information statically within its embedded memory.

The RFID reader typically follows a predefined sequence or protocol to interrogate and retrieve data from one or more RFID tags within the RF field of the reader (also known as the interrogation zone of the reader). It is noted that the interrogation zone of a reader is generally determined by the physical positioning and orientation of the reader relative to the tags, and the setting of various parameters (e.g., the transmit power) employed by the reader during the interrogation sequence.

During the typical interrogation sequence described above, the reader may be tuned to detect changes in the small signals reflected from the antennae of the passive tags, or to receive the responses generated and transmitted by the active tags.

In preferred forms, a mobile floor cleaning device transmits a low-power radio frequency (“RF”) signal and that has the ability to receive digital RF signals back from passive RFID tags. Intelligent, passive (no-power) RFID tags intercept the mobile cleaning device's RF signal and use the RF signal to power the RFID tag and then transmit an intelligent-digital RF signal back to the mobile cleaning device, informing the cleaning device of the presence of the RFID tag and what kind of RFID tag. The cleaning device has a controller with a processor having a software algorithm to interpret the digital data.

The RFID tag is preferably of the passive type, meaning that it does not transmit a signal on its own absent external stimulation. The RFID tag may thus only transmit a signal to the mobile cleaning device when the cleaning device is sufficiently near the tag and the cleaning device's RF energy has intercepted the tag.

In one form, the method of powering the RFID tags is by induction coupling, although other techniques such as propagating electromagnetic waves can be used. The RF signal from the RFID tag is a carrier signal that is transmitting an intelligent digital signal.

In order to determine the position of a cleaning machine within a facility or site, a detailed map of the facility must be created. In known autonomous machine deployment approaches, mapping has been included a dedicated mapping device and reference to detailed drawings of the facility.

In one example scenario, assume that a regular grid of passive RFID tags has been placed on the floor surface. Further, assume that the locations of these tags are known to a desired precision. Each RFID tag has a unique ID. Given the known shape of the scanning volume, the location of the machine 16 can be determined with respect to a coordinate system of which the positions of the passive REID tags are known. The scanning volume and its intersection with the grid on which the RFID tags lie, as shown in FIG. 1, can yield orientation information to a certain accuracy. The shape of the scanning volume can be used in localization. Similar to the surface shape of the RFID tags, the shape of the scan volume limits the amount of the localization information that can be recovered.

Given that the positions of the RFID tags in the environment are known, the shape of the scanning volume is used to determine the location of the tag reader. The amount of localization information can be obtained from the tag reader will be determined by the shape of the scan volume as well as tags and their placements. Using this interrogation information, the position and orientation of the cleaning machine can be determined.

Localization in larger environments, such as within a factory or an office building, can be used in, for example, delivery of consumables, security and access control. Further uses may include data caching based on the location when storage and bandwidth limit the amount of data that can be stored.

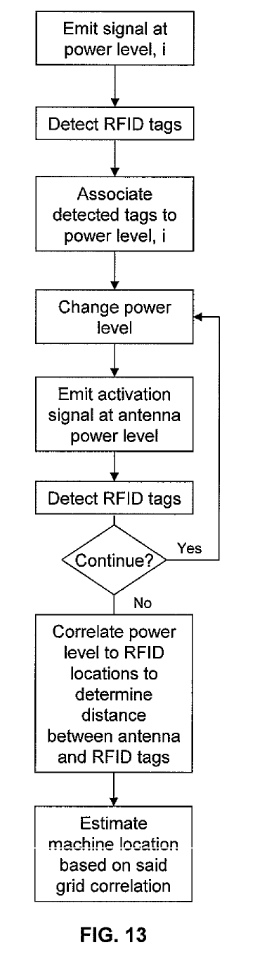

FIG. 13 illustrates one approach to machine 16 localization. RFID signal strength can be utilized as an indicator of the distance between machine 16 and RFID tags 10. When the RFID antenna emits a signal, any RFID tags within the field are triggered and transmit a return signal to the RFID reader. The size of the field of view emitted from the antenna can be varied by changing the power level supplied to the antenna at which RFID tags 10 come into view, and the approximate distance between the antenna and the tags can be estimated to yield machine 16 location.

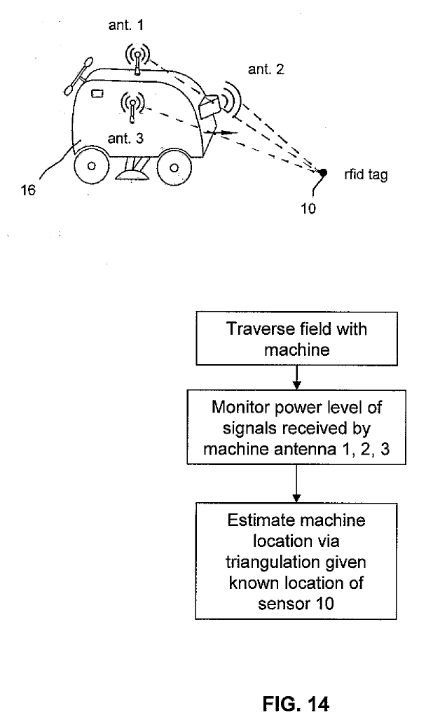

FIG. 14 illustrates another approach to machine 16 localization. If three or more antennas are included in the REID system of machine 16, each REID tag 10 can be detected by these antennas simultaneously. By monitoring the power level of the signal supplied to the antenna at which the RFID tags 10 come into view, the approximate distance between each antenna and the tags 10 can be estimated. These distances can be used to triangulate the location of the tags 10 in two dimensions.

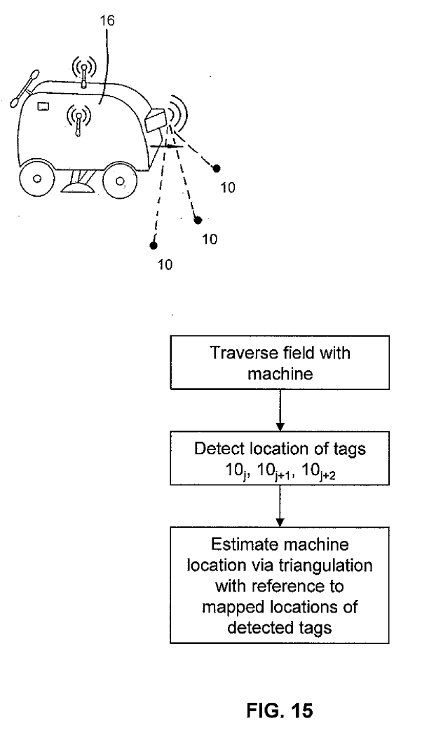

FIG. 15 illustrates yet another approach to machine localization. If multiple tags are accessible to an antenna, and assuming the location of the tags is known from a map, the distance of the tags to the antenna can be determined from the power of the signal required to trigger the tags. The position of the machine can be triangulated one three or more tags are accessed by the reader.

In yet another approach to machine localization, the size of the field of view can be affected by environmental sources such as the presence of metal or liquids on the floor. Since the operating environment may vary, the size of the field of view also changes if the power level of the signal form the antenna is constant. In order to detect the change of the field of view, a sequence of motion can be executed on the autonomous machine. The motion is required to move the field of view of the antenna over one or more reference tags multiple times at a known speed. As the tag 10 enters and exits the field of view, the size of the field of view can be determined using speed of the moving field and the duration of the tag presence in the field.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. An RFID system for a portable cleaning machine comprising:
a plurality of RFID tags arranged upon a floor surface, with each of said plurality of RFID tags including a tag carrier adapted to be secured upon the floor surface; and
a controller on the portable cleaning machine for receiving transmissions from the plurality of RFID tags, wherein machine location is identified relative to said plurality of RFID tags, with each of said plurality of RFID tags emitting an encoded signal, and with at least some of the plurality of RFID tag carriers providing visual information to personnel local to said plurality of RFID tags, said visual information including instructions or directions or warnings for said personnel.

2. The RFID system of claim 1 wherein the tag carriers are bonded to said floor surface with an adhesive or a coating.

3. The REID system of claim 2 wherein the tag carriers are at least partially embedded by a coating layer applied to the floor surface subsequent to application of the plurality of RFID tags.

4. The RFID system of claim 1 wherein the visual information is related to a hazard local to at least some of the plurality of RFID tags.

5. The RFID system of claim 1 wherein the tag carriers include visual indicia used during a method of applying the plurality of RFID tags to the floor surface, said visual indicia being used to align the tag carriers relative to each other or another structure on the floor surface during said method of applying.

6. The REID system of claim 1 wherein the tag carriers each include a plurality of REID tags.

7. An RFID system for a portable floor cleaning machine comprising:
a floor cleaning machine adapted to deliver a floor cleaning process throughout a floor field; and
a RFID tag detector on said floor cleaning machine, said RFID tag detector receiving identification information from a plurality of RFID tags on said floor field, with each of said plurality of RFID tags including a tag carrier, and with visible information defined upon a plurality of said tag carriers, said visible information providing instructions or directions or warnings to a user of the cleaning machine.

8. The RFID system of claim 7 wherein the tag carriers are bonded to said floor surface with an adhesive or a coating.

9. The RFID system of claim 8 wherein the tag carriers are at least partially embedded by a coating layer applied to the floor surface subsequent to application of the plurality of RFID tags.

10. The RFID system of claim 7 wherein the visual information is related to a hazard local to at least some of the plurality of RFID tags.

11. The RFID system of claim 7 wherein the tag carriers include visual indicia used during a method of applying the plurality of RFID tags to the floor surface, said visual indicia being used to align the tag carriers relative to each other or another structure on the floor surface during said method of applying.

12. The RFID system of claim 7 wherein the tag carriers each include a plurality of RFID tags.

13. A method of using an RFID system for a portable cleaning machine, comprising:
traversing a floor field with a portable cleaning machine during a floor cleaning operation, said floor field including a plurality of RFID tags secured to said floor field;
accessing one or more of a plurality of RFID tags during said cleaning operation;
utilizing information received during said accessing to determine a relative position of the portable cleaning machine; and
utilizing visual information presented by tag carriers of said plurality of RFID tags, said visual information providing instructions or directions to an operator of said portable cleaning machine.

14. The method of claim 13 wherein the relative position of the portable cleaning machine is based at least in part on a map stored on the portable cleaning machine.

15. The method of claim 13 wherein the relative position of the portable cleaning machine is based at least in part on a map stored on a remote control device and communicated to the portable cleaning machine.

16. The method of claim 15 further comprising:
communicating location information of the portable cleaning machine to the remote control device.

17. The method of claim 13 further comprising:
securing said plurality of RFID tag carriers to said floor field using an adhesive or a coating.

18. The method of claim 17 wherein each of said plurality of RFID tag carriers is at least partially embedded in a layer of said coating.

19. The method of claim 13 further comprising:
accessing visual indicia on said plurality of RFID tags, said visual indicia assisting in placement of the plurality of RFID tags in an aligned manner upon the floor surface.

20. The method of claim 19 wherein said aligned manner results in a grid pattern of said plurality of RFID tags upon said floor field.
